(19) United States
(12) Patent Application Publication
(10) Pub. No.: US 2009/0123586 A1
(43) Pub. Date: May 14, 2009

(54) Shaping Device for Producing Goods from a Material Strand

(76) Inventors: Stephan Hornschuch, Moenchengladbach (DE); Joachim Fuchs, Hilden (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 11/908,433

(22) PCT Filed: Mar. 17, 2006
(86) PCT No.: PCT/EP06/60818

§ 371 Date: Sep. 12, 2007

(30) Foreign Application Priority Data
Apr. 19, 2005 (DE) 10 2005 018 077.9

(51) Int. Cl. A23G 3/12

(52) U.S. Cl. 425/115

(57) ABSTRACT

A device for shaping products from a material strand comprising two eccentrically circulating separation rings each having cavities and separation ribs. The separation ribs which, during rotation, are moved together to separate individual pieces of the material strand. A rotating stamping chamber ring is provided with open stamping chambers and a pair of stamping dies are sides thereof displaceable into each stamping chamber, one from each side. The stamping dies are driven by a control unit, respectively along a curved path along which the stamping dies are displaceable, when a guiding element defining the curved paths runs about an axis. The dies are fixed to each other in such a way that, during one revolution, stamping of an individual piece begins in a peripheral angle area approximately ranging from 12° to 15° prior to a point of minimum distance between the stamping dies and ends in a peripheral angle area approximately ranging from 0° to 5° after said point of minimum distance between the stamping dies.

### PRIOR ART

The invention relates to a device for shaping goods made from a strand of material, in particular bonbon-like candies, of the type defined in further detail in the preamble to claim 1.

One such device is known from German Patent DE 29 14 967 C2. This know device for shaping bonbons or the like from a strand of material has a revolving stamping-chamber ring, with stamping chambers open on both sides parallel to its axis of rotation and with pairs of stamping dies, disposed in alignment with the stamping chambers, whose dies are displaceable in contrary fashion into the associated stamping chamber.

Laterally of the stamping-chamber ring, two separation rings revolving eccentrically to one another and rolling on one another are provided, each of which is provided with knifelike separation ribs and with half-shaping curved recesses embodied between them on its circumferential side oriented toward the other; the half-shaping curved recesses of one of the separation rings are oriented coaxially with the stamping chambers of the stamping-chamber ring. The separation ribs serve to sever individual pieces from the strand of material. The severing is done upon an approach of the two separation rings during their revolution, and the strand of material is passed between the two separation rings. After the individual pieces have been severed, they are received by the shaping curved recesses and shaped. In the further revolution of the separation rings, the pre-shaped bonbons are displaced by means of the stamping dies into the stamping chambers, embodied as through bores, of the stamping-chamber ring, where the stamping of the bonbons takes place by means of the stamping dies moved counter to one another. Next, the stamped bonbons are ejected onto a conveyor device by means of the stamping dies.

In the industry, the stamping dies are moved via a cam controller axially in the direction of the separation rings and the stamping-chamber ring or away from them, and at a point of minimum spacing between the stamping dies, a stamping force is exerted by a pressure roller onto one of the stamping dies by means of an impact motion. After that, one of the stamping dies returns to its outset position, and the bonbon is thrust out of the stamping chamber by the other stamping die and thus ejected onto the conveyor device. After that, the stamping die that accomplishes the ejection of the bonbons also back into its outset position, behind the separation rings.

It is known from examples in the industry for the cam controller for one of the stamping dies to be realized in the form of a cup-shaped body, in whose circumferential wall the curved path is made in the form of a recess. In this curved path, the associated stamping die, which revolves with the stamping-chamber ring, is guided in its revolving motion by means of a cam roller; in the range of a maximum displacement counter to the stamping chamber, play is provided for an impact motion on the part of the pressure roller in the direction of the stamping chamber.

The diametrically opposed stamping die, in examples of use known in the industry, is guided by means of a swash plate drive, and the cam control of the stamping die is realized by the tumbling motion of the swash plate that is joined to the stamping die via a ball joint.

In the known devices, at high stamping speeds, the impact load on the adjoining stamping die via the pressure roller leads to very strong dynamic loads on the entire system. By way of the flow of force through the bonbon to be stamped to the swash plate that as a rule is pneumatically prestressed, the entire apparatus is set to vibrating. The wear, particularly on the curved rollers and the curved paths, is considerable during the impact and when the cam roller is threaded back into the curved path. Furthermore, the dynamic impact loads limit the rotary speed and hence the expulsion output of the particular device and furthermore lead to very high sound levels in a stamping operation.

It is thus the object of the present invention to refine a device of the type defined at the outset such that wear in particular is reduced, and the stamping output of the device is increased.

### ADVANTAGES OF THE INVENTION

The device according to the invention for shaping goods made from a strand of material, in particular bonbon-like candies, having the characteristics of claim 1 has the advantage that the stamping extends over a comparatively large peripheral angle and thus over a longer period of time, and thus the high-viscosity material of the individual piece can be shaped with a slower deformation speed and a lesser exertion of force.

An optimal stamping course ensues if the curved paths along which the respective stamping dies of a pair of stamping dies are moved, upon a revolution about an axis of an associated guide element that predetermines the curved path of a stamping die, are fixed relative to one another such that in operation upon a revolution as a consequence of an approach of the stamping dies, the stamping of an individual piece begins in a peripheral angle range of at least approximately 12° to 15° before a point of minimum spacing between the stamping dies and ends in a peripheral angle range of at least approximately 0° to 5° after the point of minimum spacing between the stamping dies.

Because of the special adaptation of the course of the curved paths to one another with a view to an optimal course of the compressive force during the stamping operation, the stamping can be performed without the exertion of an impact force, for instance by a pressure roller, and thus advantageously not only is the large number of components reduced, but interference with the curved path in the region of a pressure roller is avoided, along with the attendant dynamic forces that cause wear and make noise. Since in a device designed according to the invention the stamping operation is effected without dynamic impact loads, vibration in the device can be avoided, and higher stamping outputs under the same load can be attained.

In an especially advantageous embodiment of the device of the invention, the guide element of at least the stamping dies disposed on one side of the stamping chambers has fixed annular bodies, whose contour and axial spacing from one another forms the curved path of stamping dies guided therein.

Such annular bodies, which can also form a kind of cup, make an inexpensive, robust realization of a curved path possible in the form of a slide track, and it is advantageous if a stamping die is guided in the curved path by means of a guide roller, which is supported on an axle element that protrudes away from a stamping die shaft substantially perpendicularly to a longitudinal axis of the stamping die.

In principle, for guiding both stamping dies of a pair of stamping dies, many of which are as a rule disposed in drumlike fashion in a circle around an axis of rotation of the guide element, guide elements that form the corresponding cured path by means of fixed annular bodies can be provided on both sides of the stamping chambers.

In an advantageous variant embodiment, the guide element of the stamping dies disposed on one of the sides of the stamping chambers is embodied with fixed annular bodies, and the guide element of the stamping dies disposed on the other side of the stamping chambers is embodied as a swash plate.

The use of a swash plate of this kind has proved itself in the industry; the swash plate is preferably supported resiliently and has pneumatic prestressing, for instance, so that if the stamping chamber is excessively full, it can yield in response to the pressure then exerted by the stamping chamber.

The guidance of stamping dies by means of a swash plate that as a rule describes a sinusoidal curve is possible in a simple way, by rotatably joining a stamping die shaft to the swash plate via a ball joint.

For attaining a high-quality stamped product, the curved paths of the guide elements on both sides can be predetermined in such a way that the spacing difference between the stamping dies over the peripheral angle between the point of the beginning of the stamping of the individual piece and the point of minimum spacing between the stamping dies amounts to from 0.1 mm and 0.7 mm, and in particular between 0.3 mm and 0.5 mm.

Further advantages and advantageous features of the subject of the invention can be learned from the description, drawings, and claims.

### DRAWINGS

One exemplary embodiment of the subject of the invention is shown schematically and in simplified form in the drawings and is explained in further detail in the ensuing description. In the drawings:

FIG. 1 shows a device of the invention for stamping bonbons or the like, made from a strand of material, in a simplified cross section;

FIG. 2 is a simplified perspective view of individual elements of the device of FIG. 1;

FIG. 3 is a top view on a detail of a curved path having a cam roller of a stamping die of the device of FIG. 1; and

FIG. 4 is a graph which shows the spacing between the stamping dies, forming one pair of stamping dies, in the course of a stamping operation.

### DESCRIPTION OF THE EXEMPLARY EMBODIMENT

In the drawings, a device 10 is shown which serves to sever and stamp bonbons 1 from a rolled-out and drawn-out strand 2 of material that in particular is filled with a liquid or semi-liquid product 3. The bonbons 1 in this present case are so-called caramels, but the device 10 shown can also be employed for shaping any other kind of candies, including pieces of chewing gum.

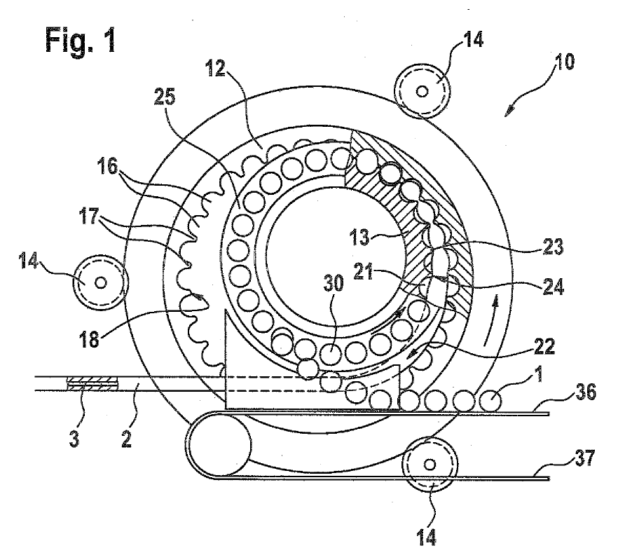

As can be seen particularly clearly in FIG. 1, the device 1 has a first, outer separation ring or knife ring 12, which cooperates with a second, inner separation ring 13. The outer separation ring 12 is supported on its outer circumference by means of three rollers 14. The outer separation ring 12, on its inner circumferential face, has shaping curved recesses 16 that are half-round in shape and adjoin one another directly. In the transition region between the shaping curved recesses 16, separation ribs 17 are embodied that extend over the entire width of the corresponding shaping curved recesses 16. The separation ribs 17 serve to sever the bonbons 1 from the strand 2 of material, for which purpose the separation ribs 17 have cutting edges 18.

The inner separation ring 13 is supported eccentrically inside the outer separation ring 12 and is driven continuously, likewise counterclockwise, by means of a drive mechanism not further shown. The inner separation ring 13 likewise has shaping curved recesses 21 of half-round shape, which upon the revolution of the inner separation ring 13 cooperate with the shaping curved recesses 16 of the outer separation ring 12. The diameter, rotary speed, and disposition of the shaping curved recesses 21 of the inner separation ring 13 are adapted to the outer separation ring 12 in such a way that upon a revolution of the two separation rings 12, 13, the strand 2, delivered to a region 22 between the two separation rings 12, 13, enters the region between the shaping curved recesses 16, 21 upon an approach of the two separation rings 12, 13 and of the corresponding shaping curved recesses 16, 21.

The inner separation ring 13, in the transition region between its shaping curved recesses 21, also has separation ribs 23 with cutting edges 24, the shape of which is adapted to the cutting edges 18 of the outer separation ring 12. As a consequence of the approach of the two separation rings 12, 13 as they revolve, the diametrically opposed cutting edges 18, 24 of the respective separation ribs 17, 23 come into contact with one another, whereupon the bonbons 1 are completely severed, as individual pieces, from the strand 2 of material.

The inner separation ring 13 is adjoined laterally by a coaxially disposed stamping-chamber ring 25, which is embodied here in one piece with the inner separation ring 13.

The stamping-chamber ring 25 has stamping chambers 30, embodied as through bores, which are aligned with the shaping curved recesses 21 of the inner separation ring 13. On both sides of these stamping chambers 25, which are disposed parallel to the axis of rotation of the stamping-chamber ring 25 and are open on both sides, stamping dies 31, 32 for stamping a bonbon 1 that has been severed from the strand 2 are provided; each two stamping dies 31, 32 forming a pair 33 of stamping dies are aligned with one of the stamping chambers 30 and are displaceable into it.

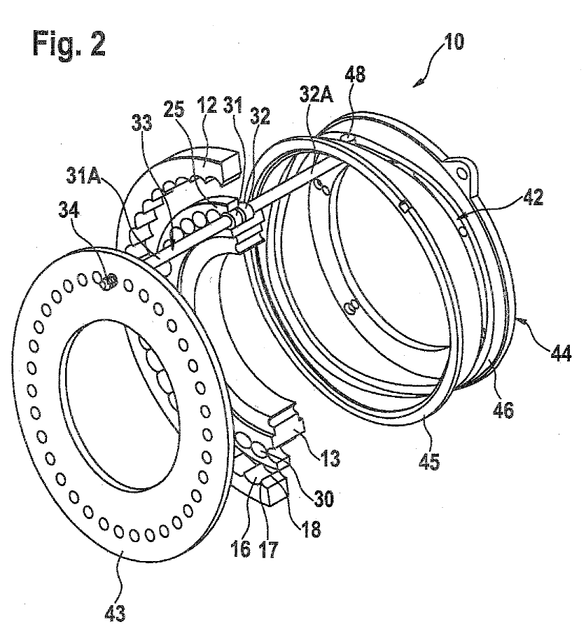

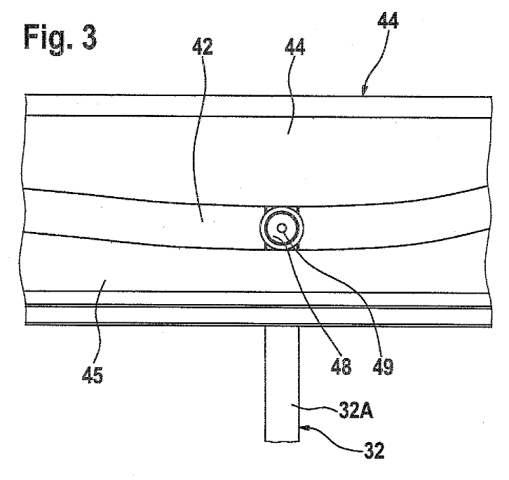

As shown in further detail in FIGS. 2 through 4, the stamping dies 31, 32 are driven via a cam controller and are movable perpendicular to the plane of the drawing in FIG. 1 upon the revolution of the inner separation ring 13. On the side toward the separation ribs 23, the stamping dies 31, 32 may have a curved form, which is adapted to the desired stamping or shaping of the bonbon 1.

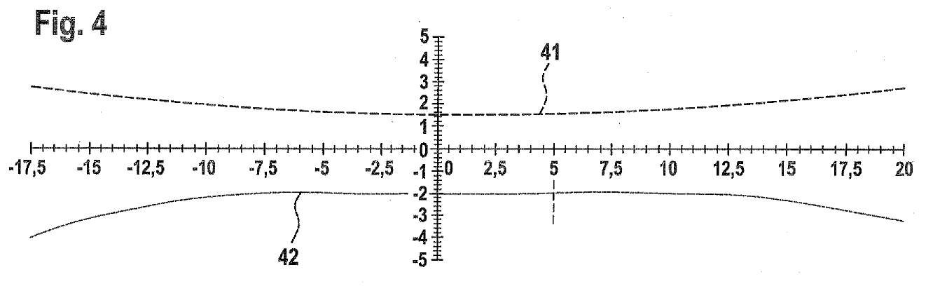

The stamping dies 31, 32, cooperating in pairs, are each guided along a respective curved path 41, 42, the course of which is shown in further detail, over a portion of the peripheral angle, in FIG. 4. Each curved path 41, 42 is predetermined by a respective guide element 43 and 44.

As the illustrative example of a pair 33 of stamping dies in FIG. 2 shows, out of a total of 35 pairs of stamping dies that are present in the embodiment shown, the guide element 43 of a first stamping die 31 of the pair 33 of stamping dies is embodied as a swash plate 43, which upon its rotation executes a sinusoidal tumbling motion and which in the present case is supported pneumatically resiliently in the axial direction. The swash plate 43 is connected transversely displaceably, by means of a ball joint 34, to the associated stamping die 31 or to a stamping die shaft 31A extending along a longitudinal axis of the stamping die 31.

The diametrically opposed stamping die 32 of the pair 33 of stamping dies is guided by a guide element 44 formed by annular bodies 45, 46; these annular bodies 45, 46 are fixed and, with their contour on the circumference and their axial spacing from one another, they embody the curved path 42, shown as a slide track, in which the stamping die 32 of the pair 33 of stamping dies slides. The stamping die 32, in the curved path 42 between the annular bodies 45 and 46, of which the annular body 45 located closer to the stamping-chamber ring 25 forms a backswept curve and the annular body 46 located farther away from the stamping-chamber ring 25 forms a pressure curve for the stamping die 32 in the region of the curved path 42, is guided by means of a guide roller 48. The guide roller 48 is supported on an axle element 49, which projects perpendicularly to a longitudinal axis of the stamping die 32 away from a stamping die shaft 32A.

Along the curved paths 41, 42, which with axially forward- and backward-deflecting regions control the axial displacement motion of the stamping dies 31, 32, the stamping dies 31, 32 of each pair 33 of stamping dies are moved first from a retracted position toward the associated stamping chamber 30, whereupon the stamping die 32 toward the annular bodies and crossing the outer separation ring 12 introduces a blank of an individual piece 1, which has been severed from the strand 2 by the separation ribs 17, 23, of a bonbon into the stamping chamber 30, in which one pair 33 of stamping dies at a time compresses the individual piece 1 from two sides.

After the compression operation, the stamping die 31 toward the swash plate returns to its outset position, while the diametrically opposed stamping die 32 is driven still farther onward, so that it ejects the finished, shaped bonbon 1 from the stamping chamber 30. Upon ejection from the stamping chamber 30, the bonbon finally reaches a feed run 36 of a continuously driven conveyor 37 in the lower region of the device 10.

The adaptation of the curved paths 41, 42 to one another can be seen especially well in the graph in FIG. 4, which shows a die spacing D in millimeters over the insertion rotation angle or peripheral angle φ; these curved paths are designed such that upon a revolution about an axis of the associated guide element 43 and 44 that defines the curved paths 41, 42, respectively, as a consequence of an approach of the stamping dies 31, 32, the stamping of the individual piece or bonbon 1 begins in a peripheral angle range of at least approximately 12° to 15° before a point D_min of minimum spacing between the stamping dies 31, 32 and ends in a peripheral angle range of at least approximately 0° to 15° after the point D_min of minimum spacing between the stamping dies.

The term stamping is understood to mean the final shaping of a bonbon 1, in which the spacing difference D between the stamping dies 31, 32 over the peripheral angle φ between the point of the beginning of stamping of the bonbon 1 and the point D_min of minimum spacing between the stamping dies 31, 32 can amount to between 0.1 mm and 0.7 mm. In the embodiment shown, the spacing difference D between the stamping dies 31, 32 during the stamping phase amounts to between 0.3 mm and 0.5 mm.

The point D_min of minimum spacing between the stamping dies 31, 32 is located, in the present embodiment, approximately 5° after an apex or 12-noon position of the swash plate 43 in a region of the least relative motion. The bonbon 1 is stamped symmetrically about the apex of the swash plate, in order to prevent the bonbon 1 from being thrust under pressure in the stamping chamber 30 and thereby possibly sticking. The goal of the cam guidance is to bypass the apex of the swash plate 43 as closely as possibly and to utilize a comparatively calm position of the stamping die 31 toward the swash plate, which is why an asymptotic approach of the stamping die 32, on the side toward the annular body, symmetrically to the apex of the swash plate 43 is selected.

In the stamping course shown, in which the stamping die 32 toward the annular body is already guided so close, between −10° and −5°, to the stamping die 31 toward the swash plate that the bonbon 1 is already shaped, and in which the curved path 42 of the stamping die 32 toward the annular body follows the curved path 41 of the stamping die 31 toward the swash plate at an angle of between −7.5° and +7.5°, and in which the point D of minimum spacing between the stamping dies 31, 32 and the end of the stamping is reached at +5°, the shaping speed of the bonbon 1 is reduced more and more as a result of the long angular path and the curve course, so that the bonbon 1 can be stamped in finished form with the most constant possible deformation force, over a wide stamping range of approximately 15°. The total deformation force for stamping out the bonbon 1 between the stamping dies 31, 32 is exerted via the guidance of the stamping dies along the curved paths 42, 43, without an additional impact motion.

An optimal course of the compression force during the stamping operation is thus established within a range of approximately +/−7.5° about the apex of the swash plate 43, and lifting of the swash plate 43 counter to the elastic prestressing is prevented by local peak forces.

Once a so-called stamping point is reached, at the point D_min of minimum spacing between the stamping dies 31, 32, the stamping dies 31, 32 move apart from one another in the course of further revolution of the separation rings 12, 13; the stamping die 31 on the side toward the swash plate is returned to its outset position along the curved path 42, and the stamping die 32 on the side toward the annular body accomplishes the ejection of the bonbon 1 from the stamping-chamber ring 30 at an approximately 8 o'clock position of the swash plate 43, before this stamping die 32 is also retracted into its outset position behind the separation rings 12, 13.

1-8. (canceled)

9. In a device for shaping goods made from a strand of material such as bonbon-like candies, the device having two separation rings revolving eccentrically to one another, each of which has curved recesses and separation ribs, and in which the separation ribs in the revolution of the separation rings approach one another and touch individual pieces, severing them from the strand, and having a revolving stamping chamber ring with stamping chambers open on both sides, and into each of which chambers, for stamping a severed individual piece, two stamping dies disposed one on each side of a stamping chamber and forming a pair of stamping dies are displaceable, the stamping dies each being driven by means of a cam controller, the improvement wherein the curved paths along which the respective stamping dies of a pair of stamping dies are moved upon a revolution about an axis of an associated guide element that predetermines the curved path are fixed relative to one another such that upon a revolution as a consequence of an approach of the stamping dies, the stamping of an individual piece begins in a peripheral angle range of at least approximately 12° to 15° before a point of minimum spacing between the stamping dies and ends in a peripheral angle range of at least approximately 0° to 5° after the point of minimum spacing between the stamping dies.

10. The device as defined by claim 9, wherein the guide element of at least the stamping dies disposed on one side of the stamping chambers has fixed annular bodies, whose contour and axial spacing from one another forms the curved path of stamping dies guided therein.

11. The device as defined by claim 10, wherein one stamping dies of each pair is guided in the curved path by means of a guide roller supported on an axle element that protrudes away from a stamping die shaft substantially perpendicularly to a longitudinal axis of the stamping die.

12. The device as defined by claim 10, wherein the curved paths of the stamping dies on both sides of the stamping chambers are formed by fixed annular bodies.

13. The device as defined by claim 11, wherein the curved paths of the stamping dies on both sides of the stamping chambers are formed by fixed annular bodies.

14. The device as defined by claim 9, wherein the guide element of the stamping dies disposed on one of the sides of the stamping chambers is embodied as a swash plate.

15. The device as defined by claim 10, wherein the guide element of the stamping dies disposed on one of the sides of the stamping chambers is embodied as a swash plate.

16. The device as defined by claim 11, wherein the guide element of the stamping dies disposed on one of the sides of the stamping chambers is embodied as a swash plate.

17. The device as defined by claim 14, wherein the swash plate is connected to a stamping die by means of a ball joint.

18. The device as defined by claim 15, wherein the swash plate is connected to a stamping die by means of a ball joint.

19. The device as defined by claim 16, wherein the swash plate is connected to a stamping die by means of a ball joint.

20. The device as defined by claim 14, wherein the point of minimum spacing between the stamping dies is located at least approximately 5° after an apex of the swash plate.

21. The device as defined by claim 15, wherein the point of minimum spacing between the stamping dies is located at least approximately 5° after an apex of the swash plate.

22. The device as defined by claim 16, wherein the point of minimum spacing between the stamping dies is located at least approximately 5° after an apex of the swash plate.

23. The device as defined by claim 17, wherein the point of minimum spacing between the stamping dies is located at least approximately 5° after an apex of the swash plate.

24. The device as defined by claim 9, wherein the curved paths are predetermined such that the spacing difference between the stamping dies over the peripheral angle between the point of the beginning of the stamping of the individual piece and the point of minimum spacing between the stamping dies amounts to between 0.1 mm and 0.7 mm.

25. The device as defined by claim 10, wherein the curved paths are predetermined such that the spacing difference between the stamping dies over the peripheral angle between the point of the beginning of the stamping of the individual piece and the point of minimum spacing between the stamping dies amounts to between 0.1 mm and 0.7 mm.

26. The device as defined by claim 11, wherein the curved paths are predetermined such that the spacing difference between the stamping dies over the peripheral angle between the point of the beginning of the stamping of the individual piece and the point of minimum spacing between the stamping dies amounts to between 0.1 mm and 0.7 mm.

27. The device as defined by claim 14, wherein the curved paths are predetermined such that the spacing difference between the stamping dies over the peripheral angle between the point of the beginning of the stamping of the individual piece and the point of minimum spacing between the stamping dies amounts to between 0.1 mm and 0.7 mm.

28. The device as defined by claim 20, wherein the curved paths are predetermined such that the spacing difference between the stamping dies over the peripheral angle between the point of the beginning of the stamping of the individual piece and the point of minimum spacing between the stamping dies amounts to between 0.1 mm and 0.7 mm.
